(19) United States
(12) Patent Application Publication
(10) Pub. No.: US 2016/0243482 A1
(43) Pub. Date: Aug. 25, 2016

(54) FILTER ELEMENT AND FILTER ARRANGEMENT

(71) Applicant: BWF TEC GMBH & CO. KG, Offingen (DE)

(72) Inventors: Holger BLAHA, Gundelfingen (DE); Thomas CARIUS, Heidenheim (DE); Martin DUNKEL, Günzburg (DE); Hans-Joerg IMMINGER, Offingen (DE)

(21) Appl. No.: 15/026,160

(22) PCT Filed: Sep. 26, 2014
(86) PCT No.: PCT/EP14/02617

§ 371 Date: Mar. 30, 2016

(30) Foreign Application Priority Data
Sep. 30, 2013 (DE) 10 2013 016 380.3

(51) Int. Cl. B01D 46/00

(52) U.S. Cl. CPC B01D 46/0002; B01D 46/0008; B01D 46/0019

(57) ABSTRACT

Proposed are a filter element, in particular in the form of a filter candle, for the dedusting of industrial gases, and a filter arrangement using the filter element. The filter element in accordance with the invention comprises a filter body and an outer framework. The filter element extends along an extension or longitudinal direction in an elongate shape. The outer framework is formed or attached at the outside of the filter body such that the filter body supports itself against the outer framework and is consequently mechanically relieved and stabilized with respect to tension, pressure, bending, and/or torsion as compared to an arrangement without an outer framework. In the filter arrangement according to the invention, a crude gas chamber and a clean gas chamber are, via one or a plurality of filter elements according to the invention, connected with each other in a fluid-mechanical manner such that, in operation, on transition of crude gas from the crude gas chamber through the one or the plurality of filter elements gas in a cleaned form passes over to the clean gas chamber.

### FIELD OF THE INVENTION

The present invention relates to a filter element, in particular in the form of a filter candle, for the dedusting of industrial gases, and to a filter arrangement using the filter element in accordance with the invention.

### BACKGROUND OF THE INVENTION

Before industrial gases can be further processed or be discharged to the environment as waste gases, they frequently have to be freed from undesired constituents or at least have to be cleaned. This concerns in particular dusts comprised in the gas, which may be retained by filtering processes, but also other gaseous constituents which are, for instance, by means of sorbents, either absorbed or, after reaction with catalysts, remain in converted form in the gas which is to be further processed or to be discharged to the environment.

Therefore, filter plants are used with the filter arrangements in which so-called filter candles are used as filter elements. Such filter candles consist of a ceramic-type basic material, are of elongate extension, e.g. of circular cylindrical shape, and are highly porous with a pore volume in the range of up to more than 90%. Compared with filter tubes, filter candles may be used in a much larger temperature range. While filter tubes may typically be used up to approx. 250° C., filter candles may typically be used up to approx. 800° C., partially even up to approx. 1,000° C. Moreover, filter candles typically have a thicker filter layer than filter tubes, so that they are particularly well suited as a carrier for a catalyst.

Due to these properties such filter candles are indeed particularly suited as filter elements for the dedusting of industrial gases and/or as a carrier material for catalysts, but they only have limited mechanical stability with respect to bearing the inherent weight, the weight of the retained dust particles, and the load of the pressure by the impacting with gas and especially the so-called dedusting pulses. In the robust industrial operation, these limitations with respect to the mechanical stability may result in damage to the individual filter elements, e.g. by the breaking and dropping of the filter candles in the filter plant, and hence to an increased emission of the crude gas actually to be filtered into the clean gas chamber of the filter plant. This is undesired.

### OVERVIEW OF THE INVENTION

It is an object of the invention to provide a filter element and in particular a filter candle for the dedusting of industrial gases, and a filter arrangement, wherein the filter operation can be performed in a particularly efficient and reliable manner and the individual filter elements and the filter arrangement of a filter plant can be handled in a particularly safe and simple manner during manufacturing.

The object underlying the invention is solved in a filter element in accordance with the invention with the features of the independent claim 1, and in a filter arrangement in accordance with the invention with the features of the independent claim 10. Advantageous further developments of the filter element in accordance with the invention are the subject matters of the dependent claims.

The present invention provides a filter element and in particular a filter candle for the dedusting of industrial gases, comprising a filter body which extends in an elongate shape along a longitudinal direction z, and an outer framework which is formed at the outside of the filter body such that the filter body supports itself against the outer framework and is consequently mechanically relieved and stabilized with respect to tension, pressure, bending, and/or torsion as compared to an arrangement without an outer framework.

The providing of an outer framework in accordance with the invention mechanically relieves and stabilizes the generally highly porous filter body of the filter element, so that overloading and hence breaking due to tension, pressure, bending, and/or torsion cannot occur in large load areas. It is therefore possible to use filter elements in accordance with the invention with a higher degree of safety in the robust industrial operation and in an enlarged parameter range with respect to the mechanical strain and the pressure strain. The risk of damages and hence of undesired emissions decreases by the use of filter elements in accordance with the invention. Due to the mechanical relief and stabilization by means of the outer framework provided, length increases of the filter elements beyond the usual degree are also conceivable, so that e.g. highly porous filter elements on ceramics basis with a manufacture length of more than 3 m may be produced and made use of With conventional filter elements without an outer framework this is not possible or only possible with a highly increased risk of additional emissions due to defects in the filter elements by breaking.

In a preferred embodiment of the filter element in accordance with the invention the outer framework comprises a plurality of mechanical support elements surrounding in their entirety the filter body externally in the manner of a cage or basket. Due to the plurality of mechanical support elements the mechanical relief can be implemented in a particularly regular manner so as to thus achieve a higher degree of stabilization of the filter element and thus increase the parameter range of a particularly reliable and safe operation. The outer framework preferably comprises at least three mechanical support elements, particularly preferred four or five mechanical support elements.

Advantageously, the mechanical elements are each designed as a wire, a rope, or a rod, or the like. The individual mechanical support elements are in particular designed to be equal or equivalent.

In a preferred embodiment of the filter element in accordance with the invention the outer framework and in particular the mechanical support elements are mechanically coupled and in particular connected with the filter body by means of first and second holding elements which are attached to the filter body at a first and/or second end of the filter body in the longitudinal direction z of the filter body. By this measure the filter body is clamped in the outer framework and thus stabilized, wherein the mechanical load is transferred to the mechanical support elements via the first and second holding elements at the ends of the filter body. This ensures a particularly reliable mechanical relief of the actual filter body and hence a particularly safe use in the robust industrial operation. In a further embodiment of the filter element in accordance with the invention the outer framework is designed such that it can be fastened directly to a head plate. The outer framework may then be suspended directly on the head plate.

Advantageously the outer framework and in particular the mechanical support elements are formed of a ceramic material or a metal material, in particular of a steel, preferably of Invar or Pernifer. An appropriately suitable material choice may achieve that, even with high temperature fluctuations, the thermal extension of the outer framework, in particular with comparison to the extension of the actual filter body, is particularly small, so that even with thermal alternating loads in industrial operation no high thermomechanical stresses occur in the filter element in accordance with the invention which may, in the case of arrangements without appropriate measures, also result in damages in operation. In a preferred embodiment of the filter element in accordance with the invention a respective mechanical support element comprises a rope adapted to be connected with a first holding element, in particular a flange sheet, by means of a turnbuckle, and with a second holding element, in particular a calotte, by means of a threaded thimble.

In a further embodiment of the filter element in accordance with the invention a respective mechanical support element is formed of a plurality of support element parts in the longitudinal direction z thereof, wherein the support element parts of a respective mechanical support element are connected with each other by means of a connection, in particular detachably.

It is particularly advantageous if, pursuant to another embodiment, the filter body of the filter element in accordance with the invention is formed of a plurality of filter body sections in the longitudinal direction z thereof. Thus, it is possible to manufacture filter bodies which are particularly long in the longitudinal extension, but may, due to their being composed of several parts, be handled in a particularly easy manner and without increased risk of breaking when an appropriate filter plant is built up.

In this respect it is of particular advantage if, in such a filter element in accordance with the invention, filter body sections of the filter body which are directly adjacent to each other in the longitudinal direction z are connected with each other via a socket joint, and in particular by making use of an adhesive. Thus, if the filter bodies are composed of several parts, the mechanical and material integrity of the entire filter body, the latter being especially necessary with respect to the filter function, is maintained or restored. Suitable adhesives are, for instance, the products “Litaflex-Kleber 600” and “Litaflex-Kleber 800” of Rex Industrie-Produkte Graf von Rex GmbH which have a temperature resistance of up to 600° C. and/or 800° C.

It is also particularly advantageous if, in a filter element in accordance with the invention, for the lateral stabilization of the mechanical support elements, transverse stabilization elements, in particular in annular shape, are formed perpendicular to the longitudinal direction z to surround the filter body externally, against which the mechanical support elements support themselves in the longitudinal direction z and/or perpendicular thereto. This makes it possible to achieve, in particular if the outer framework and in particular the mechanical stabilization elements are composed of several parts, a particularly high degree of mechanical relief and stabilization, especially against bending forces on the filter body.

In accordance with another aspect of the present invention an appropriate filter arrangement, in particular for the dedusting of industrial gases, is provided, comprising a crude gas chamber which may be supplied with crude gas, and a clean gas chamber, wherein the crude gas chamber and the clean gas chamber are, via one or a plurality of filter elements in accordance with the invention, connected with each other in a fluid-mechanical manner such that on transition of crude gas from the crude gas chamber through the one or the plurality of filter elements gas in a cleaned form passes over to the clean gas chamber. Due to the use of the filter element in accordance with the invention a particularly reliable and at the same time efficient filter operation is possible as compared to arrangements which do not make use of the filter element in accordance with the invention.

These and further aspects will be explained on the basis of the enclosed drawings.

### SHORT DESCRIPTION OF THE FIGURES

FIGS. 1A-1F illustrate schematically a first embodiment of the filter element in accordance with the invention, wherein FIG. 1A illustrates a sectional side view and FIGS. 1B-D illustrate cross-sectional views perpendicular to the longitudinal direction z along the cut lines B-B, C-C and/or D-D.

FIGS. 2A-2D illustrate schematically a second embodiment of the filter element in accordance with the invention, wherein FIG. 2A illustrates a sectional side view and FIGS. 2B-2D illustrate cross-sectional views perpendicular to the longitudinal direction z along the cut lines B-B, C-C and/or D-D.

FIG. 3A-3D illustrate schematically a third embodiment of the filter element in accordance with the invention, wherein FIG. 3A illustrates a sectional side view and FIGS. 3B-3D illustrate cross-sectional views perpendicular to the longitudinal direction z along the cut lines B-B, C-C and/or D-D.

FIG. 4 is a schematic cross-sectional view of a fourth embodiment of the filter element in accordance with the invention in longitudinal direction z.

FIG. 5A illustrates schematically in a perspective side view another embodiment of a two-part outer framework for the filter element in accordance with the invention.

FIG. 5B illustrates in a schematic and sectional side view an embodiment of a lower holding element for the construction of an embodiment of the outer framework for holding a filter body.

FIG. 6 illustrates in a schematic and perspective side view an embodiment of a single-part outer framework for the filter element in accordance with the invention.

FIG. 7A illustrates another embodiment of a two-part outer framework with a calotte as a lower holding element.

FIG. 7B illustrates in a schematic and sectional side view the detail B for fastening a mechanical support element of the embodiment of the outer framework of FIG. 7A to the calotte as the lower holding element illustrated there.

FIG. 8A illustrates in a schematic and sectional side view an embodiment of the filter arrangement in accordance with the invention making use of an embodiment of the filter element in accordance with the invention.

FIGS. 8B, 8C illustrate in schematic form the details B and/or C for fastening a plurality of calottes to the housing wall of a filter arrangement in accordance with the invention.

FIG. 9 illustrates in a schematic and sectional side view details of the fastening and sealing of a filter element in accordance with the invention in a filter arrangement in accordance with the invention.

### DETAILED DESCRIPTION OF THE EMBODIMENTS

In the following, embodiments of the present invention will be described. All embodiments of the invention as well as their technical features and characteristics may be combined with each other at will and without restriction individually or in optional composition.

Structurally and/or functionally equal, similar or equivalent features or elements will be designated with the same reference numbers in connection with the Figures in the following. A detailed description of these features or elements will not be repeated in every case.

First of all, reference will be made to the drawings in general.

The present invention relates in particular also to filter candles 1 whose filter body 10 comprises a filter material 20 of silica based fibers, i.e. for instance of fibers on the basis of aluminum oxide or silicon dioxide, i.e. for instance ceramic fibers, glass wool fibers or mineral wool fibers. Fiber ceramics of AES fibers (Alkaline Earth Silicate) may also be used such as, for instance, fiber ceramics of biodegradable fibers of calcium magnesium silicate which are dispersed in water possibly along with a binder and are sucked on a vacuum core.

Overall lengths of e.g. 3 m may be used, the collar shape may be formed to be conical or else flat, e.g. with a rectangular projection. In the region of the collar a stabilizing additional layer may be provided. A mechanical additional layer may, for instance, be provided, in particular in the form of a metal body, an expanded metal sheet or a mesh, or a chemical additional layer, in particular on the basis of a reactive system such as, for instance, silicic acid which stabilizes the collar region chemically.

In addition to the property as a filter candle 1 with excellent filter performance—dust is deposited on the outer surface—and very good regenerative capacity—e.g. by compressed air pulses, as in filter tubes—the fiber ceramic may also be used as a carrier for catalyst materials. Thus, in addition to the filtration of the dust load, the destruction of harmful gas components when flowing through the filter candle may also be achieved. The wall thickness of the filter candle 1 in accordance with the invention may e.g. be 2 cm. The wall thickness is high enough to achieve sufficient strength of the filter candle and is also helpful for doping with a catalyst since a longer contact time of the gas with the filter and/or the catalyst favors the reaction.

The candle elements 1 may be used with permanent temperatures up to 800° C.; problems will result rather with respect to plant construction and/or the materials available. For instance, the applicant requested the inventors to increase the overall length of the filter candles, e.g. to 6 m.

Since the mechanical characteristics of the construction often cannot be considered to be sufficient because e.g. the inherent weight of the filter candle 1, the weight of the filtered and adhering dust and the forces acting on the filter candle 1 due to the dedusting pulses altogether have to be borne jointly permanently, the inventors, on the one hand, made reflections of stabilizing the filter candles by an outer framework 30, e.g. of wire, ropes, or rods, especially of a ceramic material.

Alternatively or additionally, on the other hand, the reflection was made to use a two-part solution for the construction of the actual filter body 10 which is substantially easier to manufacture and to transport.

The filter candles 1 are highly porous, have a pore volume of e.g. more than 90%. This explains also the limited mechanical strength in particular uses with respect to tension, pressure, bending, and/or torsion.

The manufacturing of partial filter bodies 11, 12 with a length of e.g. 3 m is also conceivable so as to then produce the transition by a socket joint—e.g. by milling off 1 cm wall thickness, i.e. half the material thickness, outside and/or inside—which is provided with a ceramic adhesive which enables, after hardening, both a particle-tight connection of the two filter body parts or sections 11, 12 to form the entire filter body 10 and a mechanically stable connection.

In order to further secure such a connection—e.g. also during the hardening phase of the adhesive used—additional ceramic studs, pins or screws may be used which are, for instance, inserted radially from outside from the shell 10m in the transition position, preferably in stud holes, e.g. 3 or 4 of them distributed radially.

In order to keep the entire construction sufficiently stable, the outer framework 30 is helpful which forms, e.g. with mechanical support elements 31 in the form of metal ropes, wires or else in the form of rods, e.g. of ceramic, a kind of cage or basket which is to prevent the breaking and dropping of the filter candles 1 and thus to avoid increased emission by breaking.

The operation temperature may, for instance, be 400° C. to 450° C., with normal steels a cage construction may, however, be a problem due to the thermal expansion of the steel parts relative to the ceramic. Special steels such as Invar or Pernifer, however, have an advantageously smaller expansion. A support element 31 of such a special steel and with a length of 6 m will expand by only 5 mm when heated from room temperature to e.g. 400° C.

Another idea with respect to a manufacturing method for a filter arrangement 100 or filter plant 100 in accordance with the invention thus consists, for instance, in first of all placing a support basket 30, which is manufacturable in a very exact manner from ropes 31 e.g. with tolerances in the range of 1 mm, via the head plate in the plant 100 and of lowering it, e.g. via rope stoppers, until the lower half of the candle, i.e. the second or the lower filter body section 12, projects very slightly above the head plate 32. The upper part, i.e. the first or upper filter body section 11, is then inserted in the socket region, e.g. after applying an adhesive, using, for instance, a support construction for the exact linear orientation during installation, is aligned and e.g. anchored.

Subsequently, the assembled filter candle 10 is lowered completely in the plant 100 until the holding plate 131 can be connected with the head plate 32, e.g. by welding, screwing, or the like.

The lower support 33 of the candle is, for instance, a calotte which is lined e.g. with a mineral fiber felt for cushioning and/or bridging. The calotte 33 may, for instance, be inserted in a grid with a centering pin so as to avoid too large deflection from the vertical and hence the risk of breaking.

In the case of metal materials the manufacturing of the outer or support framework 30 may be achieved advantageously with the usual and established connection techniques.

Another basic idea is thus altogether the better utilization of a filter plant 100 with longer filter media 1, which entails cost advantages in plant construction. The stabilization and/or securing of the modular filter elements 1 facilitates the manufacturing and the transport to the plant 100. The complete mounting of the filter elements 1 may then be performed at the plant.

The concept of the two-part construction of the filter bodies 10 across a plurality of filter body sections 11, 12 may also be used independently of the providing of an outer framework 30 for stabilization. The multi-part construction of the filter bodies 10 facilitates in particular the manufacturing and above all the mounting of a filter body 10 in a filter arrangement 100 or filter plant 100 in accordance with the invention. Exactly with longer filter bodies 10, e.g. with a length of more than 2 m, the multi-part construction offers itself in an advantageous manner since the part-wise manufacturing and mounting also enables the implementation of longer filter bodies 10. Mounting then takes place piecewise from the bottom to the top, wherein appropriate gluing steps may be added where required. It is thus clear that, even without the providing of an outer framework, the two-part construction of a filter body 10 in accordance with the invention results in advantages as compared to conventionally mounted filter bodies.

Now, reference will be made to the drawings in detail.

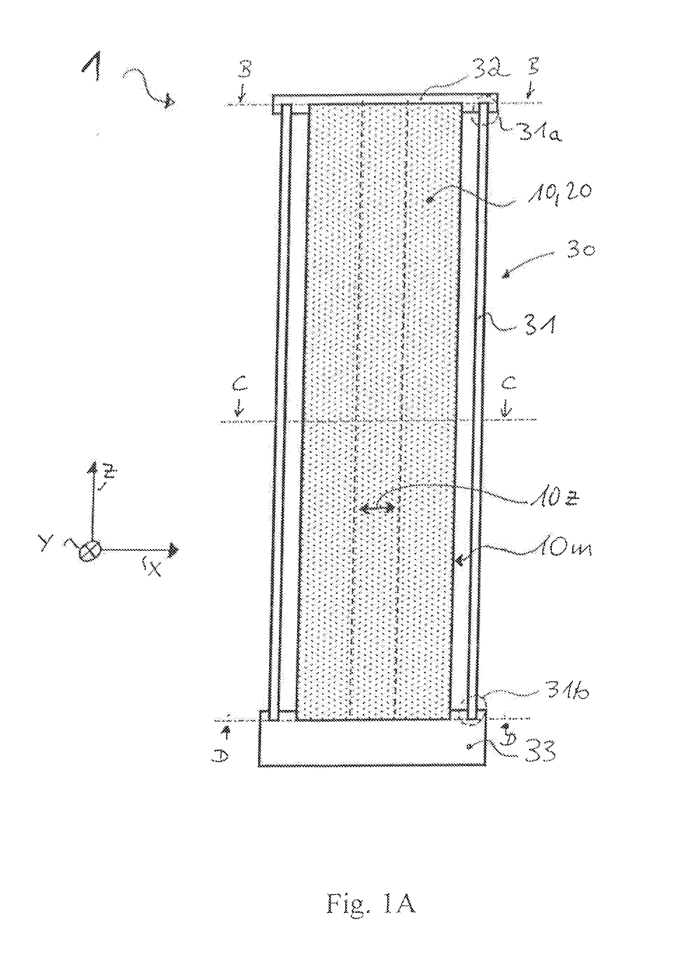

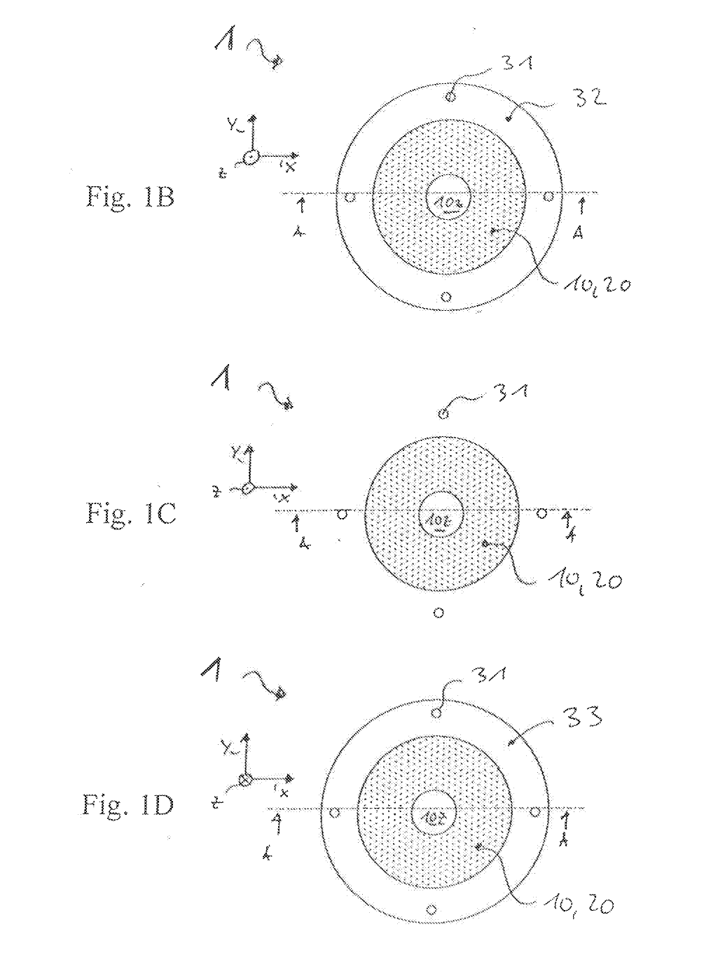

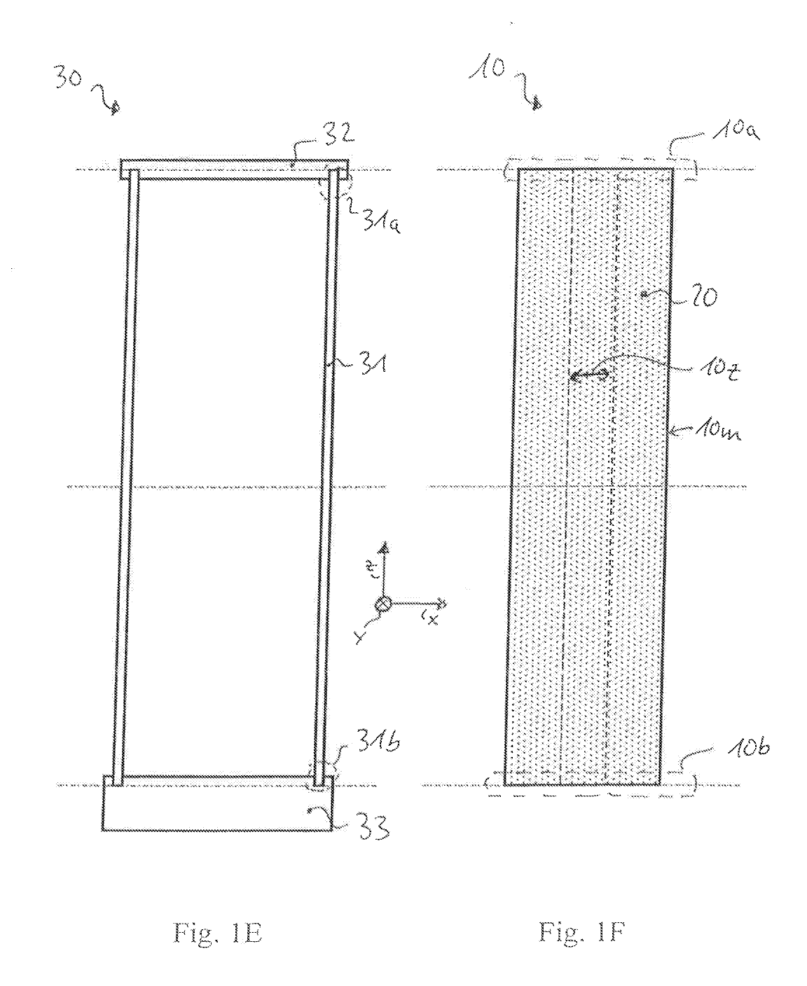

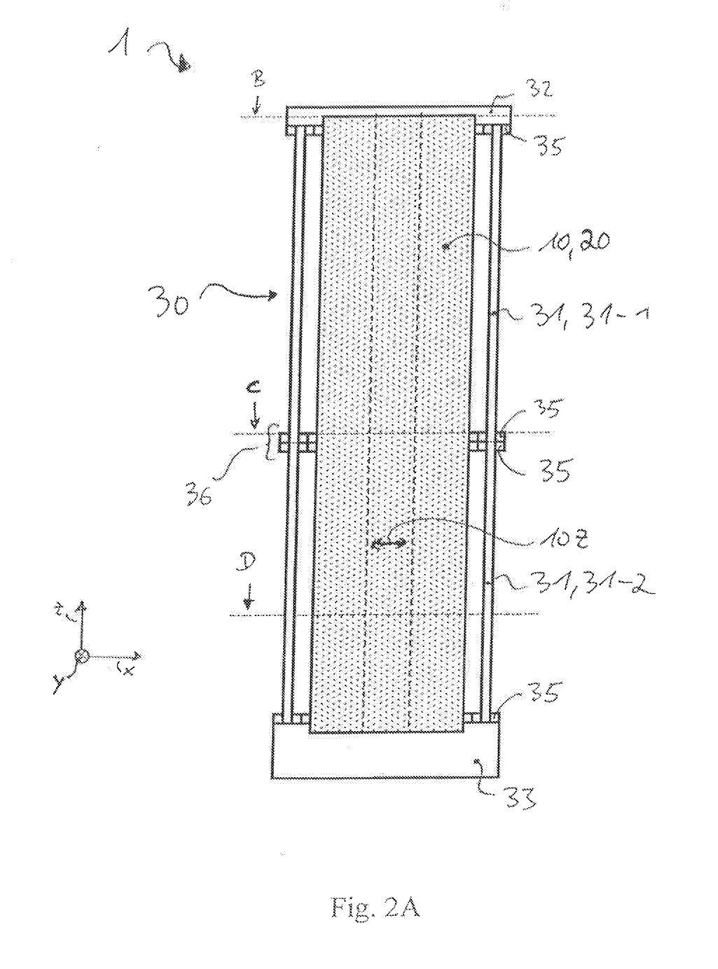

FIGS. 1A to 1F show a first embodiment of the filter element 10 in accordance with the invention.

FIG. 1A illustrates a sectional side view of the filter element 10 in accordance with the invention along the longitudinal direction z, while FIGS. 1B to 1D illustrate sections perpendicular to the longitudinal direction z along the lines B-B, C-C and/or D-D. FIG. 1E illustrates exclusively the outer framework 3 of FIG. 1A, while FIG. 1F illustrates exclusively the filter body 10 of the arrangement of FIG. 1A.

The sections illustrated in FIGS. 1B to 1D extend in a plane perpendicular to the longitudinal direction z of the filter body 10 and along the respective lines B-B, C-C and/or D-D.

In the embodiment of FIG. 1 the filter body 10 has the shape of a vertical circular cylinder and comprises a first or upper end boa and a second or lower end lob. The filter body is formed by a filter material 20, e.g. on ceramic or glass wool basis. The filter body 10 has a central recess 10z which is opened toward the first or upper end boa of the filter body 10, but may be closed toward the second or lower end lob of the filter body 10. The filter body 10 may, for instance, have an outer diameter of 150 mm, an inner diameter of 110 mm, and a wall thickness of 20 mm

The filtering process is performed, for instance, by the directed flowing—e.g. by forcing an appropriate pressure gradient—of a crude gas over the shell face 10m through the porous filter material 20 toward the central recess 10z, wherein dust particles remain adhered in the porous material 20 during the diffusion and/or, with a possibly provided catalyst material, a chemical reaction of one or a plurality of gas constituents of the crude gas takes place during the diffusion in the filter material 20, so that a gas which is modified with respect to the crude gas and which is referred to as clean gas is available in the central area 10z and may be taken from the central recess 10z to the clean gas chamber 120 in particular through the first or upper end boa of the filter body 10.

For mechanical relief and stabilization of the filter body 10 an outer framework 30 is provided which extends externally at the filter body 10 in the longitudinal direction z of the filter body 10. The outer framework 30 consists of a plurality of stabilizing elements 31 which comprise a first or upper end 31a and a second or lower end 31b by which they are attached to a first or upper holding element 32 which may also be designed as a head plate and/or a second or lower holding element 33 which may also be designed as a calotte.

The first and second holding elements 32 and/or 33 support themselves against the ends boa and 10b of the filter body 10, so that the outer framework 30 altogether surrounds the filter body 10 in the manner of a cage or basket, wherein the filter body 10, by the mechanical contact of the first and second ends boa and lob with the first and second holding elements 32 and 33, is quasi clamped between the holding elements 32 and 33 so as to achieve a mechanical relief and stabilization with respect to tension, pressure, bending, and/or torsion as compared to an arrangement without an outer framework 30.

The horizontal sectional views perpendicular to the longitudinal direction z pursuant to FIGS. 1B to 1D explain the described contexts in cross-section.

The cross-sectional form of the filter body 10 and correspondingly of the upper and lower holding elements 32 and/or 33 is not restricted to the circular shape illustrated here. Rather, elliptical shapes, square or rectangular shapes are also conceivable as base areas. If the base area has a circular shape, the forces occurring can, however, be distributed regularly in a particularly beneficial manner.

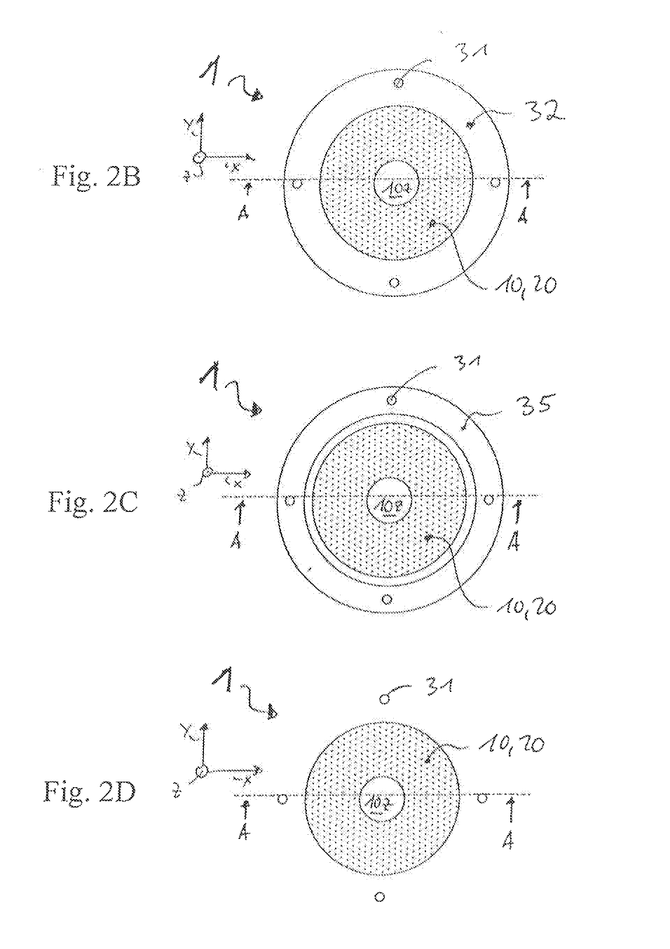

Even if, here and in the following, the mechanical support elements 31 each only support them-selves against the first and second holding elements 32 and/or 33 disposed at the head ends boa and 10b, it is also conceivable that, in the extension of the mechanical support elements 31 in the longitudinal direction z one or a plurality of transverse stabilization elements 35 are provided, as is illustrated in connection with FIGS. 2A to 2D which—apart from the described addition of the transverse stabilization elements 35—substantially represent the situation described in FIGS. 1A to 1D.

Additionally or alternatively these transverse stabilization elements 35 may also support themselves against the shell face 10 m of the filter body 10.

FIG. 2A also illustrates a separation of the mechanical support elements 31 into a first or upper support element part 31-1 and a second or lower support element part 31-2 which are anchored in the transverse stabilization elements 35 with their respective ends assigned to each other.

The sections illustrated in FIGS. 2B to 2D extend again along a plane perpendicular to the longitudinal direction z of the filter body 10 and along the respectively indicated lines B-B, C-C and/or D-D. From FIG. 2C the arrangement of the transverse stabilization element 35 in the form of a ring surrounding the filter body 10, but not touching the shell 10 m of the filter body, becomes clear.

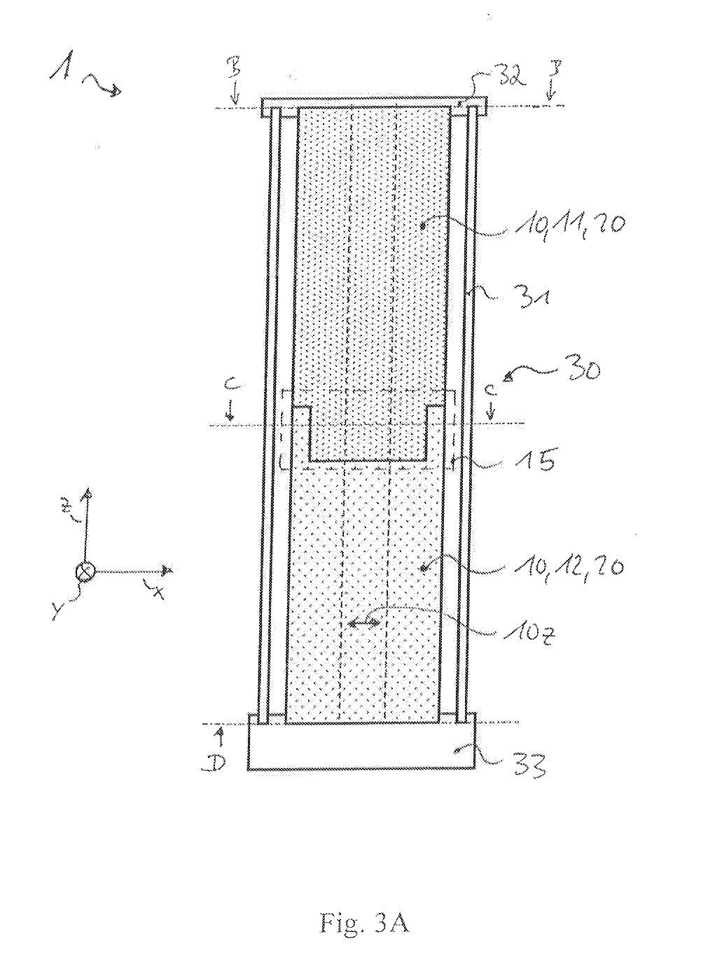

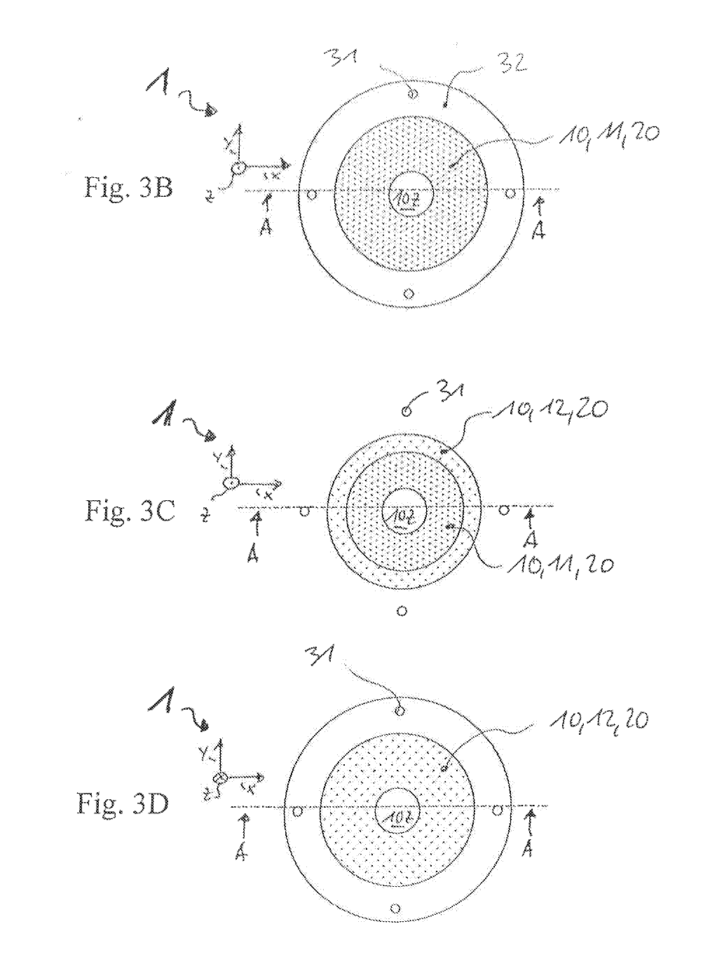

The embodiment illustrated in FIGS. 3A to 3D corresponds substantially to the embodiment of the filter element 1 in accordance with the invention illustrated in FIGS. 1A to 1F, wherein, however, in this embodiment the filter body 10 consists of a plurality of filter body sections 11 and 12 which are, by a socket joint 15 in the longitudinal direction z of the filter body 10, approximately in the middle of the total length of the filter body 10, attached to each other, wherein an adhesive may be used for stabilizing this socket joint 15 where required.

In particular the sectional illustration in FIG. 3C illustrates the arrangement of the socket joint 15 by inner and outer millings in the filter material 20 which correspond to each other.

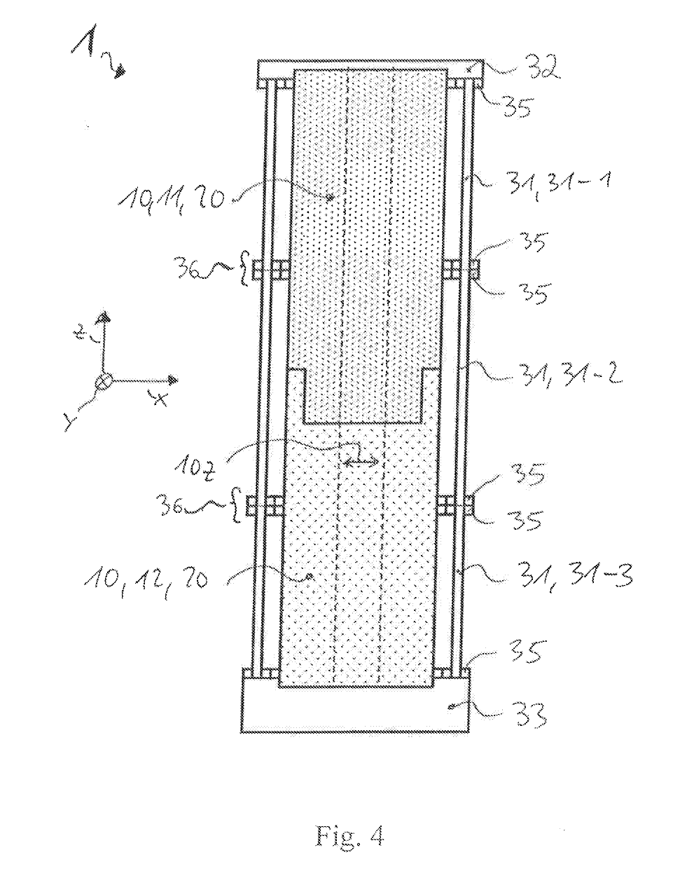

The arrangement pursuant to FIG. 4 corresponds, with respect to the construction of the filter body 10, substantially to the arrangement of FIGS. 3A to 3D. However, here a double separation of the mechanical support elements 31 into a first or upper support element part 31-1, a second or middle support element part 31-2, and a third or lower support element part 31-3 is illustrated, wherein the support element parts 31-1 to 31-3 are anchored with their respectively adjacent and assigned ends in the provided transverse stabilization elements 35.

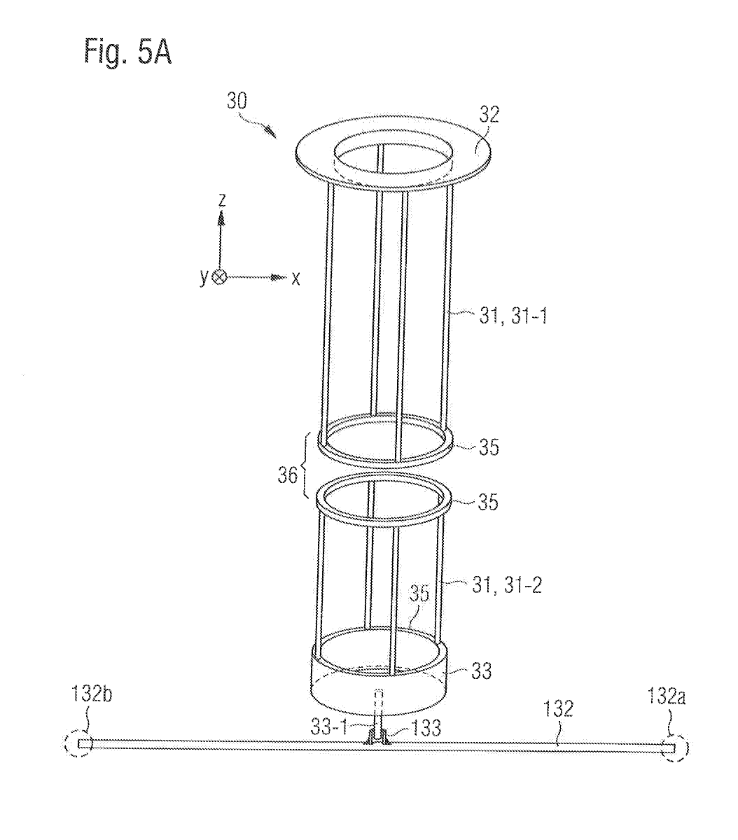

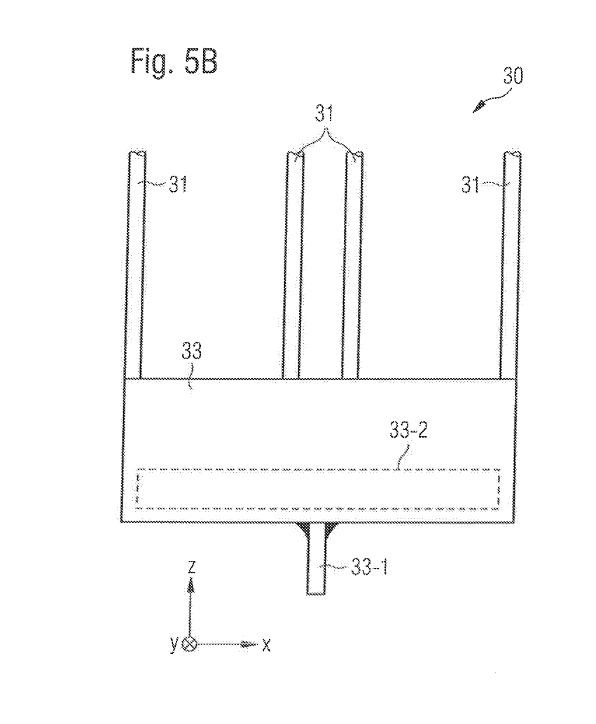

FIGS. 5A and 5B illustrate details of an outer framework 30 of another embodiment of the filter element 1 in accordance with the invention. FIG. 5A is a perspective side view of this embodiment of the filter framework 30. This arrangement corresponds essentially to the embodiment pursuant to FIGS. 2A to 2D and illustrates also a two-part construction of the outer framework 30 by an appropriate separation of the mechanical support elements 31 into a first or upper support element part 31-1 and a second or lower support element part 31-2, wherein the ends of the first and second support element parts 31-1 and 31-2 which are assigned to each other are mechanically connectable or connected with each other via correspondingly provided transverse stabilization elements 35 and a connection area 36 formed therewith, e.g. in the form of a mechanical coupling or a bayonet arrangement.

The second or lower holding element 33 of the arrangement pursuant to FIGS. 5A and 5B is again illustrated in the form of a calotte 33 having at the lower region or bottom thereof a safety pin or stud 33-1 which, in the mounted state, engages in a safety slot 133 in a filter plant 100 or filter arrangement 100, which may e.g. be mounted on a holding rod 132 or on a holding rod system 132 with first and second ends 132a and/or 132b. The sectional side view of FIG. 5B illustrates that the cartridge 33 acting as the second or lower holding element 33 may be lined inside with a sealing element or a sealing mat 33-2, for instance, a felt mat. This sealing and/or compensating element consists preferably of an elastic material maintaining high elasticity even with the provided operating temperature of the filter candle in accordance with the invention. By means of this sealing and/or compensating element it is possible to compensate for the expansion joint between the practically indifferent candle body and the slightly expanding steel framework.

With respect to the arrangement illustrated in FIGS. 5A to 5B it has to be noted that the support elements 31 may be mounted prior to the complete mounting of the filter element 1, i.e. outside the filter body 10. In this case, e.g. also a rigid and multi-part embodiment of the outer framework 30 is given, wherein the first or upper holding element 32 is designed as a kind of flange with a sealing arranged at the bottom so as to separate, after the mounting, the crude gas chamber 110 from the clean gas chamber 120 in a particle-tight and gas-tight manner such that a fluid-mechanical connection therebetween exists exclusively via the filter body/filter bodies 10.

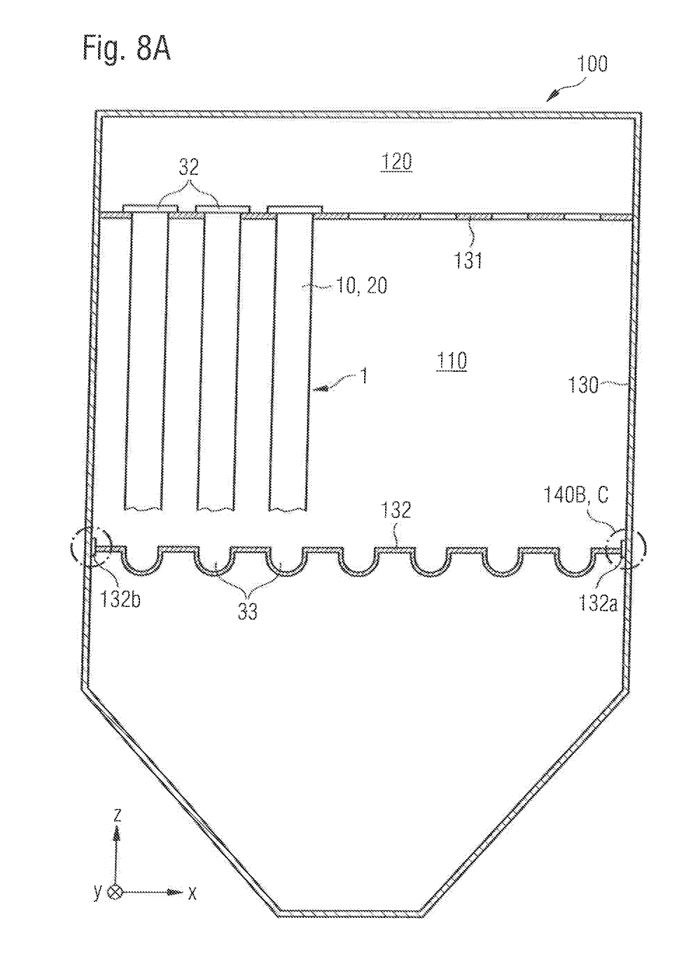

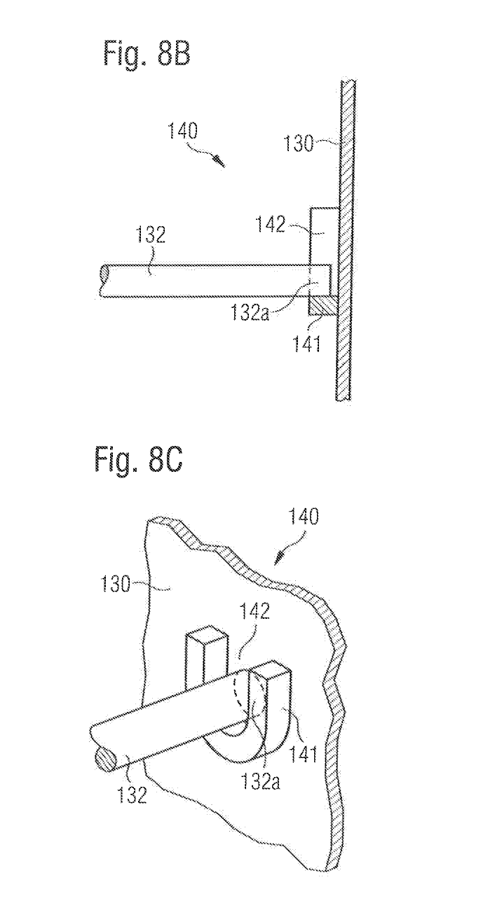

The rod 132 formed with the receptions 133 for the safety studs 33-1 is positioned as a rigid element in the crude gas chamber 110 of the filter plant 100 or filter arrangement 100 and below the filter elements 1 and may thus also stabilize a plurality of similar filter elements 1. The mounting of this reception rod 132 will be described in detail in connection with FIGS. 8A to 8C.

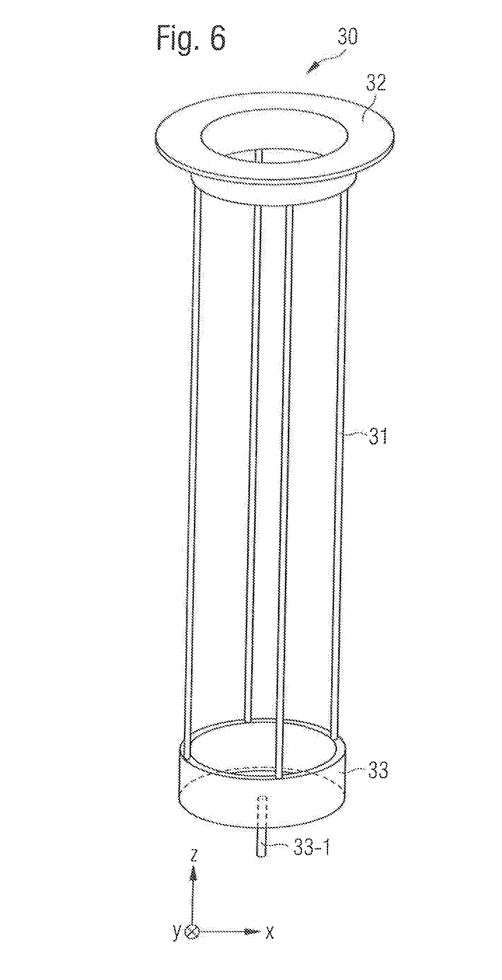

The embodiment for an outer framework 30 for a filter element 1 in accordance with the invention illustrated in a perspective side view in FIG. 6 resembles in its basic structure the embodiment illustrated in FIGS. 1A to 1F. Here it is, however, a single-part embodiment which may in particular also be designed with single-part and flexible support elements 31 making use of steel ropes. The second or lower holding element 33 may be designed in the manner of a rectangular pot or a ball calotte or cartridge having again a safety pin 33-1 arranged at the underside thereof for mounting, fixing and aligning in the crude gas chamber 110.

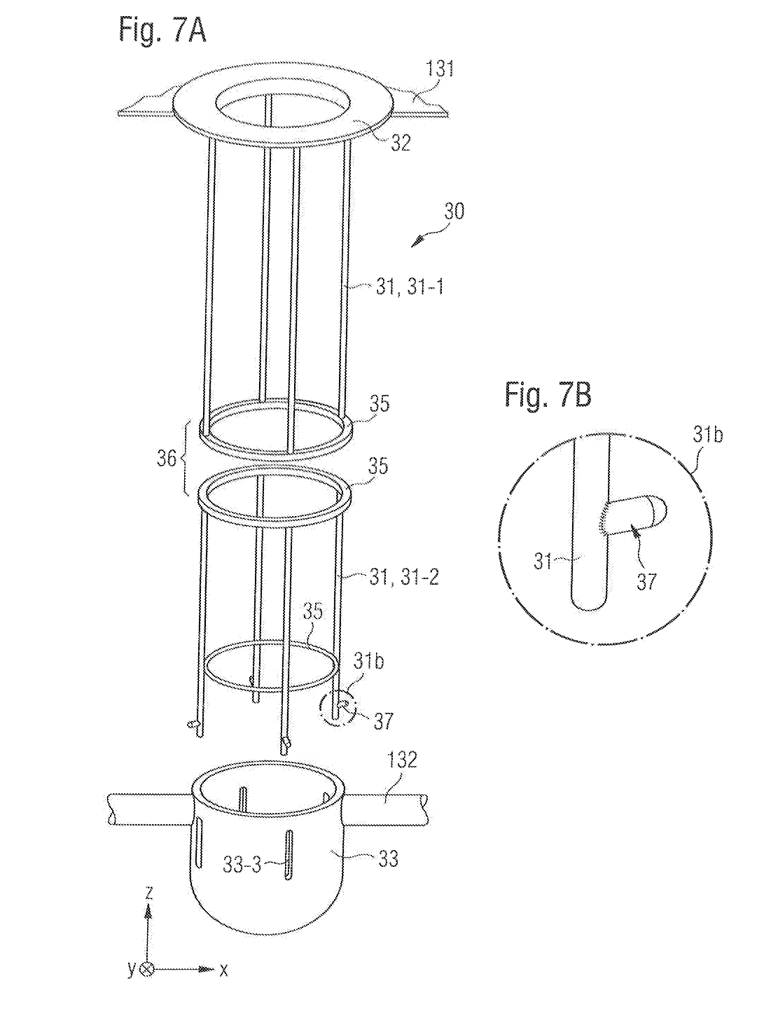

FIGS. 7A and 7B describe a further embodiment of an outer framework 30 for a filter element 1 in accordance with the invention. The outer framework 30 is substantially of three-part construction, wherein the mechanical support elements 31 have a two-part structure with a respective first or upper support element part 31-1 and a second or lower support element part 31-2. The ends of the first and second support element parts 31-1 and 31-2 which are assigned to each other are anchored in annular transverse stabilization elements 35 and are connected with each other via an appropriate connection area 36, as already described above. While the first or upper ends 31a of the support elements 31 support themselves anchored in the first or upper holding element 32, the second or lower ends 31b of the support elements 31 comprise, in addition to an optionally additionally provided transverse stabilization element 35 in the form of a ring, a stud element 37 extending radially outward and serving to engage in longitudinal recesses 33-3 or long holes 33-3 of the second or lower holding elements 33 in calotte form for fixing, positioning, or aligning. FIG. 7B illustrates in greater detail the region of the second or lower end 31b of a respective support element 31 with the fastening stud 37 for threading into the long holes 33-3.

It has to be noted that here the calottes 33 which form the second or lower holding elements 33 are preferably attached firmly to a rod system 132 or a holding rod 132.

With respect to the embodiment pursuant to FIGS. 7A and 7B it has to be noted that the positioning and aligning of the mechanical support elements 31 of a respective filter element 1 is performed by the positioning of the studs 37 in the long hole 33-3 of the calotte 33. The arrangement of the firmly installed calottes 33 has to be performed such that the studs 37 of a respective mechanical support element 31 are threaded in at the top in the manner of a longitudinal rod. This arrangement with the threading in in the long hole 33-3 has the advantage that, under thermal expansion with increasing temperature, the longitudinal rod of the mechanical support element 31 may expand downward when guided through the long hole 33-3 without having to change the position of the calotte, so that a rigid mounting of the calottes 33 is possible.

FIGS. 8A to 8C now show a use of the filter element 1 in accordance with the invention in a filter arrangement 100 or filter plant 100.

The sectional side view pursuant to FIG. 8A illustrates an embodiment of the filter arrangement 100 in accordance with the invention. It consists of a crude gas chamber 110 and a clean gas chamber 120 which are surrounded by a joint housing with an appropriate housing wall 130 and which are fluid-mechanically separated from each other by means of a so-called holding plate 131, wherein a fluid-mechanical connection of the crude gas chamber 110 and the clean gas chamber 120 takes place exclusively via filter elements 1 in accordance with the invention which are received in the holding plate 131.

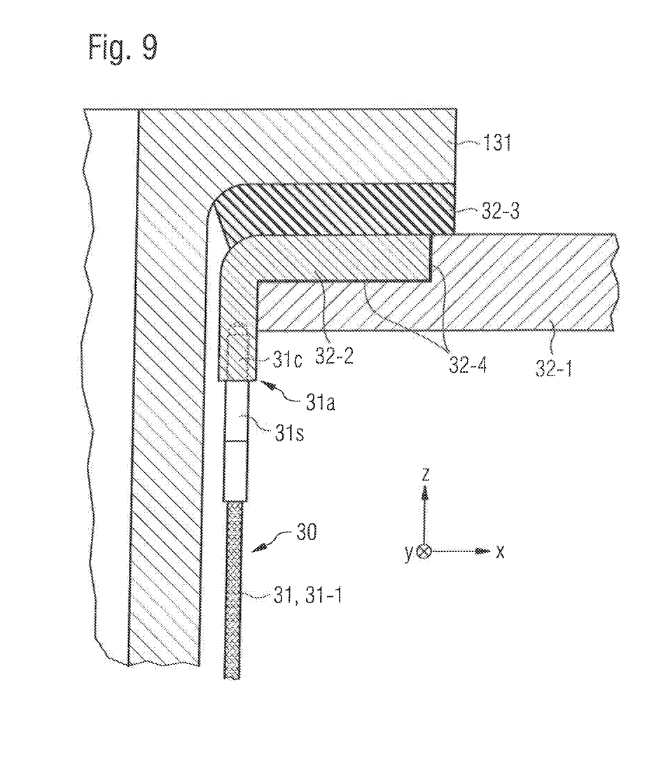

The filter elements 1 penetrate the holding plate 131 and are mounted thereon in a gas-tight and particle-tight manner by means of the first or upper holding element 32 in the form of a head plate. An embodiment of this gas-tight and particle-tight mounting is explained in detail below in connection with FIG. 9.

The filter bodies 10 of the provided filter elements 1 extend contrary to the longitudinal direction z downward and are based with their second or lower ends lob in calottes serving as second or lower holding elements 33 which are in turn attached to a corresponding holding rod system 132 or to a holding rod 132. For simplification of illustration, the outer frameworks 30 of the filter elements 1 in accordance with the invention are not illustrated explicitly here.

The holding rod system 132 or the holding rod 132 comprises first and second ends 132a and 132b which are mounted e.g. detachably in the housing wall 130 via corresponding fastening areas 140.

FIGS. 8B and 8C describe in a sectional side view and/or in a sectional perspective side view details of an embodiment of the fastening area 140 and of the reception of the holding rod 132. The fastening area 140 consists substantially of a fastening rest 141 in U-shape which opens with its fastening recess 142 upward in the longitudinal direction z and serves as a rest for a respective end 132a, 132b of the holding rod 132 for the calottes as second or lower holding elements 33.

FIG. 9 illustrates in a schematic and sectional side view details of the fastening and sealing of an upper end 1a of a filter element 1 in accordance with the invention via the outer framework 30 to the holding plate 131 of a filter arrangement 100 in accordance with the invention.

It illustrates in particular that a respective mechanical support element 31 of the outer frame-work 30 of this embodiment may be formed of a flexible steel rope, e.g. of Pernifer. The first or upper end 31a of the support element 31 is anchored via a fastening element 31c in the first or upper holding element 32 which is formed by an offset head plate 32-1 radially surrounded by a support ring 32-2 which receives the actual fastening elements 31c of the mechanical support elements 31. The head plate 32-1 is glued with the support ring 32-2 preferably by an adhesive 32-4, for instance, Litaflex-Kleber 600 or Litaflex-Kleber 800. For the mechanical fixing and stabilization of the respective filter body 10 in the outer framework 30, a turnbuckle 31s by which the steel rope which is flexible as such and which forms the mechanical support element 31 may be tensioned is positioned in the region of the first or upper end 31a of the mechanical support element 31. For simplification of illustration the filter body 10 which is to be clamped by the turnbuckle 31s by means of the steel rod 31 is not illustrated in FIG. 9. The head plate 32-1 surrounded by the support ring 32-2 is sealed against the holding plate 131 by a seal 32-3.

In accordance with the present invention, a filter element 1, in particular in the form of a filter candle, for the dedusting of industrial gases, and a filter arrangement 100 making use of the filter element 1 are thus proposed.

The filter element 1 in accordance with the invention comprises a filter body 10 and an outer framework 30. The filter element is formed with or of a ceramic filter material 20 and extends along an extension or longitudinal direction z in an elongate shape. The outer framework 30 is formed or attached at the outside of the filter body 10 such that the filter body 10 supports itself against the outer framework 30 and is consequently mechanically relieved and stabilized with respect to tension, pressure, bending, and/or torsion as compared to an arrangement without an outer framework. In the filter arrangement 100 according to the invention, a crude gas chamber 110 and a clean gas chamber 120 are, via one or a plurality of filter elements 1 according to the invention, connected with each other in a fluid-mechanical manner such that, in operation, on transition of crude gas from the crude gas chamber 110 through the one or the plurality of filter elements 1 gas in a cleaned form passes over to the clean gas chamber 120.

### LIST OF REFERENCE NUMBERS

1 filter element in accordance with the invention, filter candle
10 filter body
10a first or upper end of the filter body 10
10b second or lower end of the filter body 10
10m shell face of the filter body 10
10z central recess of the filter body 10
11 first or upper filter body section
12 second or lower filter body section
15 socket joint
20 filter material
30 outer framework
31 mechanical support element
31-1 first support element part or first support element section
31-2 second support element part or second support element section
31-3 third support element part or third support element section
31a first or upper end/first or upper end region of the support element 31
31b second or lower end/second or lower end region of the support element 31
31c fastening element of the support element 31
31s turnbuckle
32 first or upper holding element, head plate
32-1 offset head plate
32-2 support ring
32-3 seal
32-4 adhesive
33 second or lower holding element, calotte, cartridge
33-1 safety stud, safety pin
33-2 sealing element, sealing mat
33-3 long hole
35 transverse stabilization element, stabilizing ring
36 connection area, coupling, bayonet
100 filter arrangement, filter plant
110 crude gas chamber
120 clean gas chamber
130 housing wall
131 holding plate
132 holding rod, holding rod system
132a first end of the holding rod 132
132b second end of the holding rod 132
133 reception for the safety stud 33-1
140 fastening area
141 fastening rest
142 fastening recess
z longitudinal direction

1. A filter element for the dedusting of industrial gases, comprising
a filter body extending in an elongate shape along a longitudinal direction, and
an outer framework which is formed at the outside of the filter body such that the filter body supports itself against the outer framework and is consequently mechanically relieved and stabilized with respect to tension, pressure, bending, and/or torsion as compared to an arrangement without an outer framework.

2. The filter element according to claim 1,
wherein the outer framework comprises a plurality of mechanical support elements surrounding in their entirety the filter body externally in the manner of a cage.

3. The filter element according to claim 2,
wherein the mechanical support elements are equal to each other.

4. The filter element according to claim 2,
wherein the outer framework and the mechanical support elements are mechanically coupled and connected with the filter body by means of first and second holding elements which are attached to the filter body at a first and/or second end of the filter body in the longitudinal direction of the filter body.

5. The filter element according to claim 2,
wherein the outer framework and the mechanical support elements are formed of a ceramic material or a metal material.

6. The filter element according to claim 2,
wherein a respective mechanical support element is formed of a plurality of support element parts in the longitudinal direction thereof, and
wherein the support element parts of a respective mechanical support element are detachably connected with each other via a connection.

7. The filter element according to claim 1,
wherein the filter body is formed of a plurality of filter body sections in the longitudinal direction thereof.

8. The filter element according to claim 7,
wherein filter body sections of the filter body which are directly adjacent to each other in the longitudinal direction are connected with each other via a socket joint by making use of an adhesive.

9. The filter element according to claim 1,
wherein, for the lateral stabilization of the mechanical support elements, transverse stabilization elements, in annular shape, are formed perpendicular to the longitudinal direction to surround the filter body externally, against which the mechanical support elements support in the longitudinal direction and/or perpendicular thereto.

10. A filter arrangement for the deducting of industrial gases, comprising
a crude gas chamber which may be supplied with crude gas, and
a clean gas chamber,
wherein the crude gas chamber and the clean gas chamber are, via one or a plurality of filter elements according to claim 1, connected with each other in a fluid-mechanical manner such that on transition of crude gas from the crude gas chamber through the one or the plurality of filter elements gas in a cleaned form passes over to the clean gas chamber.

11. The filter element according to claim 1, wherein the filter element is a filter candle.

12. The filter element according to claim 3, wherein the mechanical support elements are designed as a wire.

13. The filter element according to claim 3, wherein the mechanical support elements are designed as a rope.

14. The filter element according to claim 3, wherein the mechanical support elements are designed as a rod.

15. The filter element according to claim 5, wherein the outer framework and the mechanical support elements are formed of a steel material.

16. The filter element according to claim 5, wherein the outer framework and the mechanical support elements are formed of a steel material configured to expand 5 mm or less for an element of 6 m in length when operated at a temperature range of room temperature to 450° C.
